(19) United States
(12) Patent Application Publication
(10) Pub. No.: US 2011/0051250 A1
(43) Pub. Date: Mar. 3, 2011

(54) OPTICAL ELEMENT, AND PROCESSING APPARATUS AND METHOD FOR REDUCING REFLECTION

(75) Inventors: Goro Fujita, Kanagawa (JP); Seiji Kobayashi, Kanagawa (JP); Yoshinari Kawashima, Kanagawa (JP)

(73) Assignee: Sony Corporation, Tokyo (JP)

(21) Appl. No.: 12/858,540

(22) Filed: Aug. 18, 2010

(30) Foreign Application Priority Data
Aug. 26, 2009 (JP) 2009-195688

(51) Int. Cl. G02B 5/00; B23K 26/36

(52) U.S. Cl. 359/601; 219/121.68; 219/121.69; 219/121.8

(57) ABSTRACT

An optical element includes: a pit forming portion of a material that forms a pit in the vicinity of each focal point of a predetermined light beam upon condensation, wherein the pits are formed in such a manner that the volume percentage of the pits with respect to the material at distances from a light incident face becomes smaller away from the incident face.

### BACKGROUND OF THE INVENTION

1. Field of the Invention

The present invention relates to optical elements, and processing apparatuses and methods for reducing reflection. The invention is suitable for, for example, optical elements for which surface reflection of light needs to be prevented.

2. Description of the Related Art

Lenses that use translucent substrates such as glass and plastic have been widely used as optical elements. To reduce the surface reflected light and increase transmission characteristics, such lenses often use a multilayer film coating that includes an anti-reflective film formed by vapor deposition of material such as an oxide on surface.

In the multilayer film coating, the number of coating layers is increased to reduce incident angle dependence or wavelength dependence. This complicates the designing procedures and increases the number of manufacturing steps.

As a countermeasure, an element with a structure called a moth-eye structure has been proposed in which microscopic indentations equal to or shorter than the wavelength of light are formed on a lens surface to continuously vary the refractive index of the lens along the thickness direction (see, for example, JP-A-2003-131390).

The moth-eye structure does not depend on the incident angle of external light, and has anti-reflection effects over a relatively wide wavelength range.

### SUMMARY OF THE INVENTION

A problem of the moth-eye structure, however, is that designing of indentations that can produce desirable refractive index changes along the thickness direction is difficult, because the refractive index along the thickness is varied using the microscopic indentations formed on the surface of an optical element.

Accordingly, there is a need for an optical element, and a processing apparatus and method for reducing reflection with which surface reflection of light can be relieved with great freedom of design.

According to an embodiment of the present invention, there is provided an optical element that includes a pit forming portion of a material that forms a pit in the vicinity of each focal point of a predetermined light beam upon condensation, wherein the pits are formed in such a manner that the volume percentage of the pits with respect to the material at distances from a light incident face becomes smaller away from the incident face.

With the optical element, the average refractive index in a predetermined range of an equal distance from the incident face along the normal direction can be gradually varied from the refractive index of air to the refractive index of the material toward inside away from the incident face, and the extent of refractive index change can be set with great freedom.

According to another embodiment of the present invention, there is provided a processing apparatus for reducing reflection that includes: a light source that emits a light beam; an objective lens that condenses the light beam to form pits inside an optical element of a predetermined material; a moving unit that moves a focal point position of the light beam; and a control unit that controls the light source and the moving unit to form the pits inside the optical element in such a manner that the volume percentage of the pits with respect to the material at distances from a light incident face of the optical element becomes smaller away from the incident face.

With the processing apparatus, the average refractive index in a predetermined range of an equal distance from the incident face of the optical element along the normal direction can be gradually varied from the refractive index of air to the refractive index of the material toward inside away from the incident face, and the extent of refractive index change can be set with great freedom.

According to the embodiments of the present invention, the average refractive index in a predetermined range of an equal distance from the incident face of the optical element along the normal direction can be gradually varied from the refractive index of air to the refractive index of the material toward inside away from the incident face, and the extent of refractive index change can be set with great freedom. The present invention can thus realize an optical element, and a processing apparatus and method for reducing reflection with which surface reflection of light can be relieved with great freedom of design.

### BRIEF DESCRIPTION OF THE DRAWINGS

FIG. 1 is a schematic diagram representing a configuration of lens processing apparatuses of First and Second Embodiments.

FIG. 2 is a schematic diagram representing the concept of pit formation.

FIGS. 3A to 3E are schematic diagrams representing a pit forming method of First Embodiment.

FIGS. 4A and 4B are schematic diagrams representing a lens substrate of First Embodiment.

FIGS. 5A and 5B are schematic diagrams representing a lens substrate with no pits.

FIGS. 6A and 6B are schematic diagrams representing a lens substrate of Second Embodiment.

FIG. 7 is a schematic diagram representing a configuration of a pit forming apparatus of Third Embodiment.

FIGS. 8A to 8D are schematic diagrams representing a pit forming method of Third Embodiment.

FIGS. 9A and 9B are schematic diagrams illustrating an anti-reflective sheet and a lens according to Third Embodiment.

FIGS. 10A to 10D are schematic diagrams illustrating lens substrates of other embodiments.

### DESCRIPTION OF THE PREFERRED EMBODIMENTS

The following will describe embodiments of the present invention, in the order below.

1. First Embodiment (an example in which the distribution density of pits is varied)

2. Second Embodiment (an example in which the volume of individual pits is varied)

3. Third Embodiment (an example in which an anti-reflective sheet is used)

4. Other embodiments

### 1. First Embodiment

### 1-1. Configuration of Lens Processing Apparatus

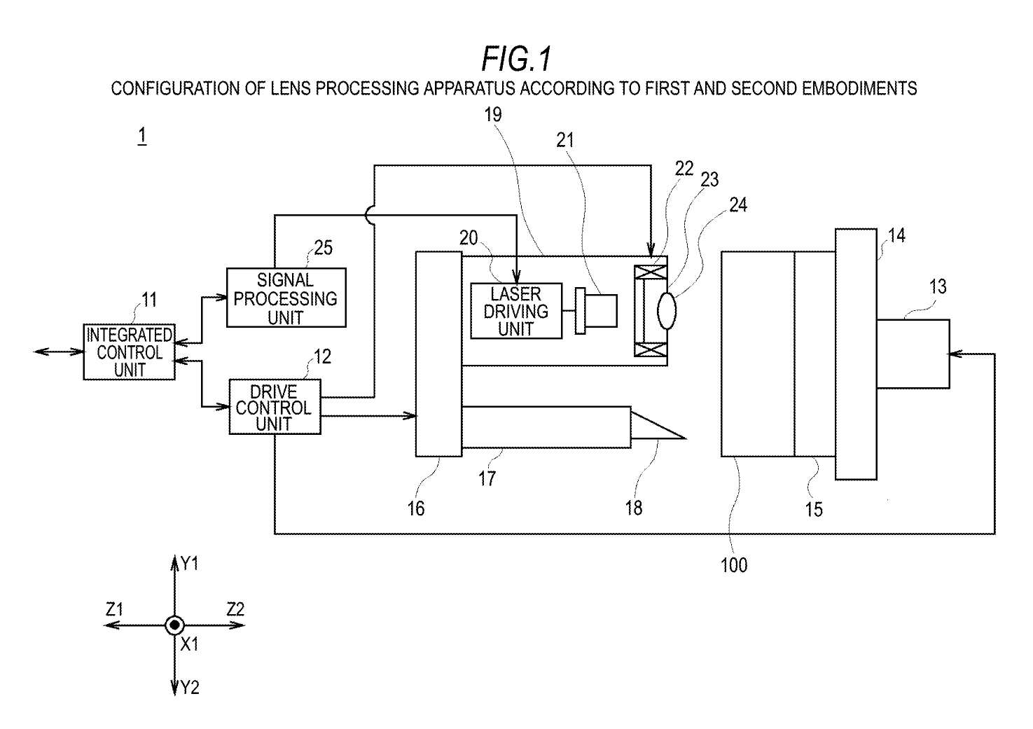

A lens processing apparatus 1 illustrated in FIG. 1 is configured as a whole to cut a lens substrate 100 (workpiece) into a desired shape, and to form pits by irradiating the lens substrate 100 with a light beam.

An integrated control unit 11 is adapted to integrally control the lens processing apparatus 1. The integrated control unit 11 is configured to include a CPU (Central Processing Unit), a ROM (Read Only Memory) storing various programs and other data, and a RAM (Random Access Memory) used as a work memory for the CPU (all not shown).

In actual practice, the integrated control unit 11 executes various programs to drive and rotate a spindle motor 13 about the Z axis via a drive control unit 12, and to thereby rotate a main shaft 14 at a desired speed. A lens anchoring unit 15 is attached to the main shaft 14. Accordingly, the lens anchoring unit 15 rotates with the main shaft 14.

The lens substrate 100 (workpiece) is anchored on the lens anchoring unit 15. Accordingly, the lens substrate 100 rotates with the lens anchoring unit 15.

In this manner, the integrated control unit 11 is adapted to drive and rotate the spindle motor 13 via the drive control unit 12 to rotate the lens substrate 100 at a desired speed.

The lens substrate 100 is formed of optical glass. Irradiation of the lens substrate 100 with a light beam of a predetermined light quantity causes a local temperature increase in the vicinity of the focal point, and a pit is formed by the resulting thermochemical reaction. Before cutting, the lens substrate 100 is substantially cylindrical in shape with the bottom face in contact with the lens anchoring unit 15.

The optical glass is a blend of at least 5 or 6 kinds of materials such as silica stone, lanthanum oxide, and boric acid, and melts at temperatures of about 1,200° C. to 1,400° C. The optical glass allows for passage of incident light from one surface to the other with high transmittance. The optical glass has a refractive index of about 1.5.

The pits formed in the lens substrate 100 are filled with the gas generated by the heat-decomposition of the optical glass. Since the main component of the lens substrate 100 is oxide material such as silica stone, the gaseous component in the pits is considered to be oxygen. The refractive index of oxygen is about 1.0, substantially the same as that of air but different from that of the optical glass.

The integrated control unit 11 is also adapted to execute various programs to control the driving of a support unit 16 via the drive control unit 12 in three directions along the X, Y, and Z axes, and in the rotational direction about the X axis.

A tool anchoring unit 17 is attached to the support unit 16. The tool anchoring unit 17 includes a tool 18 made of, for example, diamond, used to cut the lens substrate 100.

In this manner, the integrated control unit 11 controls the driving of the support unit 16 via the drive control unit 12 in such away that the tool 18 anchored on the tool anchoring unit 17 is controlled at a desired position and at a desired angle with respect to the lens substrate 100.

In addition to the tool anchoring unit 17, an optical unit 19 is also attached to the support unit 16. The optical unit 19 is thus movable with the tool anchoring unit 17 under the drive control of the drive control unit 12.

The optical unit 19 has substantially the same configuration as a common optical pickup, and includes a laser driving unit 20, a laser diode 21, an actuator 22, a lens holder 23, and an objective lens 24.

In forming pits in the lens substrate 100, the integrated control unit 11 performs predetermined processes by, for example, supplying information such as pit volume to a signal processing unit 25, and produces laser control signals according to the information and sends the signals to the laser driving unit 20 of the optical unit 19.

The integrated control unit 11 also controls the driving of the actuator 22 of the optical unit 19 via the drive control unit 12. In this way, the integrated control unit 11 causes the lens holder 23 carrying the objective lens 24 to lightly move in directions toward and away from the lens substrate 100 for the position adjustment of the objective lens 24. The integrated control unit 11 is thus able to move the focal point of a light beam along the depth direction (Z direction) of the lens substrate 100.

The laser driving unit 20 produces a laser drive signal based on the laser control signal supplied from the signal processing unit 25, and sends the laser drive signal to the laser diode 21. In response to the laser drive signal, the laser diode 21 emits a pit-forming light beam according to the laser drive signal to irradiate the lens substrate 100 via the objective lens 24 that has undergone a position adjustment. In this way, the optical unit 19 is able to form pits in the lens substrate 100.

The signal processing unit 25 controls parameters such as the peak value, pulse width, and period of the laser control signal sent to the laser driving unit 20, under the control of the integrated control unit 11. In this way, the signal processing unit 25 is able to control parameters such as the peak value of light beam intensity, and the irradiation time and period of the light beam shone on the lens substrate 100. The pit volume increases as the light intensity and/or the irradiation time of the light beam shone on the lens substrate 100 increase.

In the actual forming of the pits that proceeds concurrently with the cutting of the lens substrate 100, the drive control unit 12 rotates the spindle motor 13 under the control of the integrated control unit 11 to cause the rotation of the main shaft 14 and the lens substrate 100 anchored on the lens anchoring unit 15.

The drive control unit 12 then moves the support unit 16 to contact the tool 18 with the lens substrate 100 undergoing rotation, cutting the lens substrate 100 and forming a lens of a desired shape.

Here, the signal processing unit 25 drives the laser diode 21 under the control of the integrated control unit 11, and causes the laser diode 21 to emit a light beam of a predetermined light intensity. The objective lens 24 at a controlled position focuses the light beam onto the position distant apart from the surface of the lens substrate 100 by a desired distance (depth) along the Z direction.

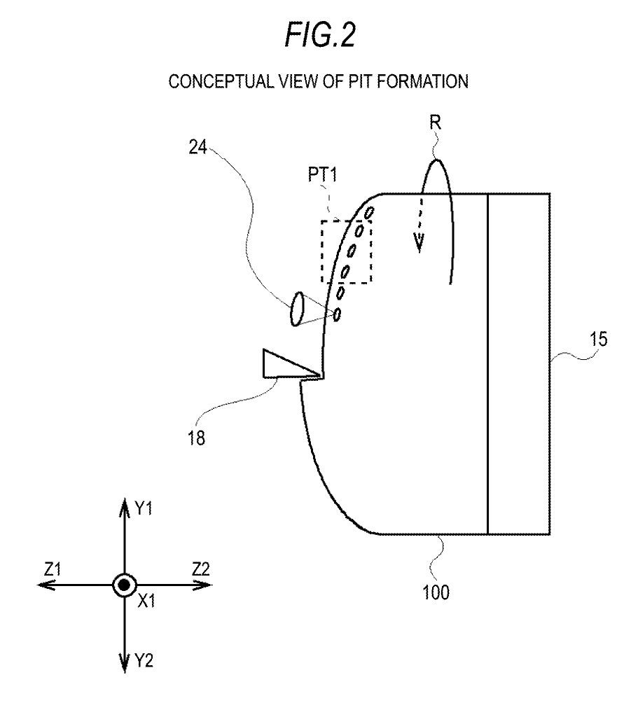

FIG. 2 is a conceptual diagram representing the cutting of the lens substrate 100 and pit formation. In FIG. 2, only the lens anchoring unit 15, the lens substrate 100, the objective lens 24, and the tool 18 are shown, and the other components are omitted. Here, the lens substrate 100 is being cut to provide a planoconvex lens that transmits and condenses the parallel rays incident on the Z1 side, and has a focal point on the Z2 side.

The rotation of the lens anchoring unit 15 in direction R about the Z axis causes the lens substrate 100 to rotate with the lens anchoring unit 15. The lens substrate 100 is thus cut by the tool 18 in contact with the substrate surface. Pits are then formed in the lens substrate 100 as the light beam through the objective lens 24 irradiates the lens substrate 100.

As illustrated in FIG. 1, the optical unit 19 carrying the objective lens 24 is attached to the support unit 16 as is the tool anchoring unit 17 anchoring the tool 18. As such, the objective lens 24 moves in three directions along the X, Y, and Z axes, and in the rotational direction about the X axis, following the tool 18. Note, however, that, by the provision of the actuator 22, the movement of the objective lens 24 is independent from the tool 18 with regard to the movement directions toward and away from the lens substrate 100.

As described above, the lens processing apparatus 1 is adapted to form pits by irradiating the lens substrate 100 with a light beam through the objective lens 24 that is lightly moved in directions toward and away from the lens substrate 100 while undergoing movement following the movement of the tool 18 as it cuts the lens substrate 100.

### 1-2. Formation of Pits

The following describes the procedures of forming the pits in the lens substrate 100. The pits that prevent reflection of external rays are formed in the surface of the lens substrate 100 on the side of the objective lens 24 (the Z1 side; hereinafter, also referred to as “incident face 100N”).

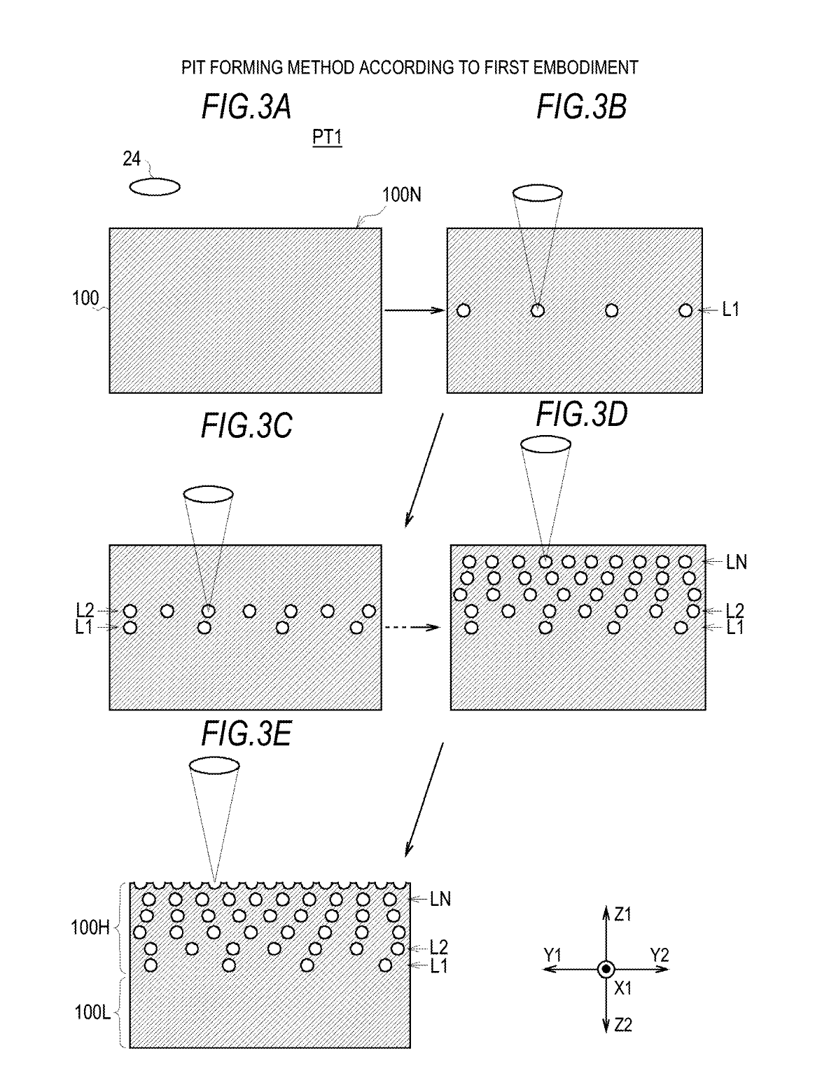

FIGS. 3A to 3E are magnified cross sectional views of a lens substrate portion PT1 of the lens substrate 100 (a portion on the Z1 side) illustrated in FIG. 2, showing how the pits are formed.

The lens processing apparatus 1 first uses the drive control unit 12 to move the objective lens 24 with the support unit 16, and focuses a light beam at a focal point position within the lens substrate 100 of FIG. 3A a predetermined distance away from the incident face 100N, as illustrated in FIG. 3B. The lens processing apparatus 1 then uses the signal processing unit 25 to control the laser driving unit 20, causing the laser diode 21 to emit a light beam of a predetermined light intensity for a predetermined time period. As a result, a pit is formed. In this manner, the lens processing apparatus 1 forms a plurality of pits, all in substantially the same volume, by shining a light beam of the same intensity at different positions for the same duration without changing the distance from the incident face 100N.

As a result, as illustrated in FIG. 3B, a layer of pits (hereinafter, also referred to as “pit layer L1”) is formed in the lens substrate 100 a certain distance (depth) away from the incident face 100N. The pits actually formed have substantially a spherical shape, even though they appear circular in FIGS. 3A to 3E.

The lens processing apparatus 1 then uses the drive control unit 12 to control the objective lens 24, and, as illustrated in FIG. 3C, forms a plurality of pits having substantially the same volume as the pits of the pit layer L1 by moving the focal point position of the light beam closer to the incident face 100N than the pit layer L1. As a result, as in the pit layer L1, a layer of pits (hereinafter, also referred to as “pit layer L2”) is formed in the lens substrate 100 a certain distance away from the incident face 100N.

Here, the lens processing apparatus 1 forms larger numbers of pits than in the pit layer L1. Accordingly, the pit density is higher in the pit layer L2 than in the pit layer L1 in the lens substrate 100.

The lens processing apparatus 1 repeats the same procedure, each time forming a layer of pits of substantially the same volume but in greater numbers than in the previous layer farther away from the incident face 100N, by controlling the objective lens 24 with the drive control unit 12, and shining a light beam on the lens substrate 100 at a focal point position that is gradually moved toward the incident face 100N in each procedure.

In this manner, the lens processing apparatus 1 controls the support unit 16 and the objective lens 24 using the drive control unit 12 to shine a light beam at a focal point position that is gradually moved toward the incident face 100N of the lens substrate 100 from a position farther away from the incident face 100N.

As a result, as shown in FIG. 3D the pits are formed in the lens substrate 100 in three dimensions in the X, Y, and Z directions, and the pits in the Z direction form layers.

The lens processing apparatus 1 forms pits of substantially the same volume in the lens substrate 100 in gradually increasing densities toward the incident face 100N.

If the lens processing apparatus 1 were to reverse the procedure and form pits a direction away from the incident face 100N of the lens substrate 100, there is a possibility that the light beam shone on the lens substrate 100 passes through the previously formed pits at nearer positions.

The light beam that passes through the previously formed pits is influenced by the difference in the refractive indices of the lens substrate 100 and the pits, and may fail to be focused at a desired focal point position. This may lead to poor product quality.

In this case, the lens processing apparatus 1 may fail to form pits at desired positions of the lens substrate 100, or may fail to form pits of desired volumes.

To avoid the influence of the previously formed pits, the lens processing apparatus 1 is adapted to sequentially form pits toward the incident face 100N of the lens substrate 100 from a position father away from the incident face 100N.

Then, as illustrated in FIG. 3E, the lens processing apparatus 1 moves the focal point position of the light beam to the incident face 100N of the lens substrate 100, and shines a light beam so as to increase the pit density more than in the pit layer LN closest to the incident face 100N illustrated in FIG. 3D.

However, in FIG. 3E, because the light beam is shone on the surface of the lens substrate 100, substantially hemispherical depressions with substantially half the volume of the pits formed inside the lens substrate 100 are formed on the incident face 100N. As a result, indentations are formed on the incident face 100N of the lens substrate 100.

In the following, the term “pit forming portion 100H” is used to refer to a portion of the lens substrate 100 where the pits are formed. A portion beneath the incident face 100N past the pit forming portion 100H inside the lens substrate 100 where no pits are formed is referred to as an “optically functional portion 100L.”

The surface indentations of the lens substrate 100 may be formed using a chemical treatment, for example, such as etching. However, irradiation of a light beam is more desirable than chemical treatment, because it can simplify the configuration of the lens processing apparatus 1, and can reduce the number of working processes.

### 1-3. Varying Refractive Index

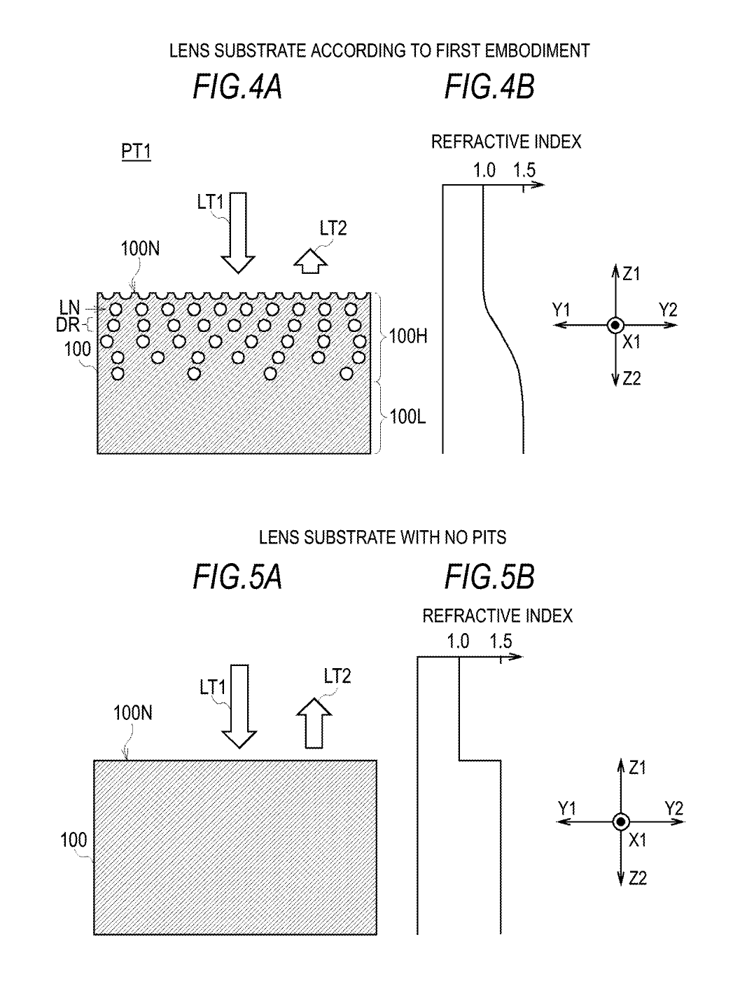

As illustrated in FIG. 4A, pits of substantially the same volume are formed inside the lens substrate 100.

Here, a range of a predetermined width in a direction normal to the incident face 100N (depth direction) equally distant apart from the incident face 100N is depth range DR. For example, when the depth range DR is a range that contains a single pit layer, the material of the lens substrate 100 and the pits are present in a predetermined volume ratio in the depth range DR. In the following, the depth range DR is described as being a range that includes a single pit layer distant apart from the incident face by a predetermined distance.

The average refractive index in the depth range DR (hereinafter, also referred to as “depth range refractive index”) is believed to take a value between the refractive index of the material of the lens substrate 100 and that of the pits according to the volume ratio of the pits with respect to the material of the lens substrate 100.

As noted above, the refractive index of the pits is about 1.0, about the same as the refractive index of air outside the lens substrate 100. The lens substrate 100 (optical glass) has a refractive index of about 1.5.

Thus, in the predetermined depth range DR, the depth range refractive index approaches 1.5 as the pit volume decreases with respect to the material of the lens substrate 100, and approaches 1.0 as the pit volume increases with respect to the material of the lens substrate 100.

As illustrated in FIG. 4A, the number of pits in the lens substrate 100 increases toward the incident face 100N, and gradually decreases away from the incident face 100N into the substrate. FIG. 4A also shows incident light LT1 shone on the lens substrate 100 on the side of the air outside the lens substrate 100.

Thus, as represented in FIG. 4B, the depth range refractive index gradually increases from 1.0 to 1.5 toward inside the lens substrate 100 away from the incident face 100N.

In the pit layer LN, the depth range refractive index is about 1.0, because of the high pit density attributed to the very large numbers of pits formed in the layer. In contrast, the depth range refractive index is about 1.5 in the pit layer L1, because the number of pits formed in the layer is very small and thus the pit density is low. Thus, there is only a small difference in refractive index at the interface between air and the lens substrate 100.

As a rule, where there is a difference in refractive index between two materials on which light is incident, some of the incident rays are reflected at the interface between the two materials. The percentage of the reflected light with respect to the incident light becomes smaller as the difference in refractive index between two materials decreases.

Thus, as illustrated in FIG. 4A, the reflected light LT2 that occurs as the incident light LT1 is reflected at the lens substrate 100 has a much smaller light quantity than the incident light LT1.

Further, because the lens substrate 100 has indentations on the incident face 100N, the difference in refractive index between air and the lens substrate 100 can be further reduced to continuously vary the refractive index. Thus, reflection of external light on the lens substrate 100 can be suppressed.

### 1-4. Operation and Effects

Configured as above, the lens processing apparatus 1 shines a light beam on the lens substrate 100 formed of an optical glass.

The lens substrate 100 irradiated with a light beam of a predetermined light quantity undergoes a thermochemical reaction as a result of a local temperature increase in the vicinity of the focal point, and a pit is formed. The lens processing apparatus 1 forms pits of substantially the same volume in such a manner that the pits gradually decrease in density toward inside the lens substrate 100 away from the incident face 100N. The lens processing apparatus 1 also shines a light beam onto the incident face 100N of the lens substrate 100 to form indentations.

Thus, in the lens substrate 100, the volume ratio of pits with respect to the material gradually becomes smaller toward inside, away from the incident face 100N.

Because the refractive index of air is about 1.0 and that of the lens substrate 100 about 1.5, an abrupt change occurs in refractive index at the interface between air and the incident face 100N of the lens substrate 100, as represented in FIG. 5B, when no pits are formed in the lens substrate 100 as illustrated in FIG. 5A.

In this case, the percentage of the reflected light LT2 on the incident face 100N that occurs as a result of the reflection of the incident light LT 1 externally incident on the lens substrate 100 increases relative to the incident light LT1, as illustrated in FIG. 5A.

In contrast, such an abrupt change does not occur in the lens substrate 100 of the present embodiment (FIGS. 4A and 4B), because the refractive index continuously varies toward inside the lens substrate 100 away from the air side.

Accordingly, only a small difference in refractive index occurs at the interface between air and the lens substrate 100, and reflection of externally incident light at the surface of the lens substrate 100 can be suppressed.

Further, because the lens processing apparatus 1 uses the integrated control unit 11 to control the light beam shone on the lens substrate 100, the distribution density of the pits in the lens substrate 100 can be freely set.

The lens processing apparatus 1 is thus able to set the extent of refractive index change with great freedom over the range extending from the incident face 100N of the lens substrate 100 into the substrate.

The anti-reflection processes of related art can be used to adjust the extent of refractive index change in a direction normal to the incident face. For example, in the multilayer film coating, adjustments can be made by changing the ways a high refractive index layer and a low refractive index layer are combined. In the moth-eye structure, adjustments are possible by varying the indentation height. However, these are difficult to achieve in terms of design.

In contrast, with the lens processing apparatus 1 of the present embodiment, the extent of refractive index change in a direction normal to the incident face 100N of the lens substrate 100 can be adjusted simply by adjusting the density of the pits formed in the lens substrate 100 at each distance from the incident face 100N.

In contrast to the moth-eye structure of the related art in which indentations are formed only on the surface subjected to the anti-reflection process, the lens substrate 100 of the present embodiment forms pits in a normal direction of the incident face 100N of the lens substrate 100. Thus, changes in refractive index can be reduced further by forming large numbers of layers relatively deep down the lens substrate 100 in a normal direction of the incident face 100N. Further, because the lens processing apparatus 1 can form pits down into the lens substrate 100 simply by shining a light beam on an optical glass having a high light transmissivity, the apparatus configuration can be simplified.

The multilayer film coating of the related art requires materials such as oxides, in addition to the material subjected to the anti-reflection process. In contrast, irradiation of a light beam is all that is required for the lens substrate 100 of the present embodiment, and other materials are not required. This simplifies the configuration of the lens processing apparatus 1 for the anti-reflection process, and reduces the material cost.

According to the foregoing configuration, the lens processing apparatus 1 shines a light beam on the lens substrate 100 under the control of the integrated control unit 11, and forms pits of substantially the same volume in such a manner that the pits gradually decrease in density toward inside the lens substrate 100 away from the substrate surface. The refractive index of the lens substrate 100 thus continuously varies toward inside the lens substrate 100 away from the air side. The lens processing apparatus 1 is therefore able to gradually vary the depth range refractive index of the lens substrate 100 from the refractive index of air to the refractive index of the material toward inside the substrate away from the incident face 100N, and set the extent of refractive index change with great freedom.

### 2. Second Embodiment

### 2-1. Pit Formation

A lens processing apparatus 1 (FIG. 1) of Second Embodiment is configured in the same way as the lens processing apparatus 1 of First Embodiment.

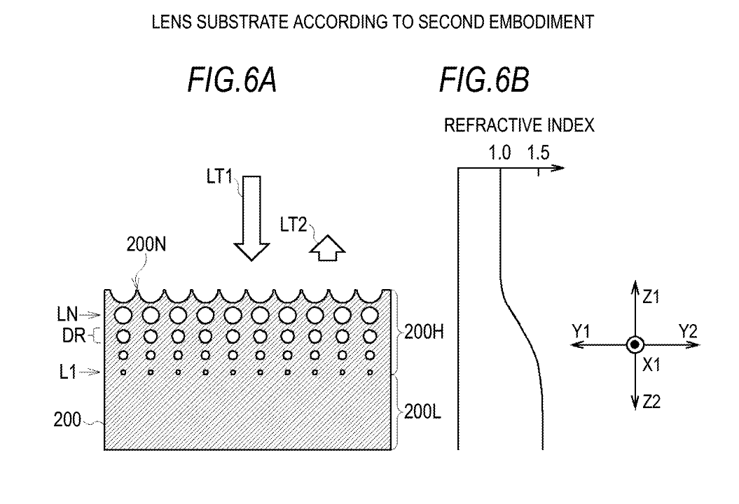

FIG. 6A is a magnified cross sectional view illustrating a portion of a lens substrate 200 as with FIG. 4A. The pits for preventing the reflection of external light are formed in the incident face 200N on the objective lens 24 side (Z1 side) of the lens substrate 200.

As in First Embodiment, the lens processing apparatus 1 of Second Embodiment controls the objective lens 24 using the drive control unit 12, and forms the pits by shining a light beam at a focal point position that is gradually moved toward the incident face 200N of the lens substrate 200 from a position farther away from the incident face 200N.

In the lens processing apparatus 1, for example, the irradiation time of a light beam for the lens substrate 200 is gradually extended under the control of a signal processing unit 25 as the focal point position is moved toward the incident face 200N of the lens substrate 200 from a position farther away from the incident face 200N. Note, however, that the lens processing apparatus 1 maintains the same irradiation time for the pits formed at the same distance from the incident face 200N.

Thus, pits of gradually increasing volumes are formed in the lens substrate 200 from inside the substrate toward the incident face 200N. Note, however, that the pit volume is substantially the same for the same layer in the lens substrate 200. Further, indentations are formed on the incident face 200N of the lens substrate 200.

In the following, the term “pit forming portion 200H” is used to refer to a portion of the lens substrate 200 where the pits are formed. A portion beneath the incident face 200N past the pit forming portion 200H inside the lens substrate 200 where no pits are formed is referred to as an “optically functional portion 200L.”

### 2-2. Varying Refractive Index

As illustrated in FIG. 6A, the lens substrate 200 has pits that gradually decrease in volume away from the incident face 200N.

Thus, in the lens substrate 200, the volume percentage of the pits with respect to the material of the lens substrate 200 in the depth range DR gradually decreases toward inside the substrate from the incident face 200N.

As noted above, the refractive index of the pits is about 1.0, substantially the same as the refractive index of air outside the lens substrate 200. The lens substrate 200 (optical glass) has a refractive index of about 1.5.

Thus, as represented in FIG. 6B, the depth range refractive index gradually increases from 1.0 to 1.5 toward inside the lens substrate 200 away from the incident face 200N.

In the pit layer LN, the depth range refractive index is about 1.0, because the pits formed in the layer have a large volume and thus a large volume percentage with respect to the material of the lens substrate 200. In contrast, the depth range refractive index is about 1.5 in the pit layer L1, because the pits formed in the layer have a small volume and thus a small volume percentage with respect to the material of the lens substrate 200. Thus, there is only a small difference in refractive index at the interface between air and the lens substrate 200.

Thus, as illustrated in FIG. 6A, the reflected light LT2 that occurs as the incident light LT1 is reflected at the lens substrate 200 has a much smaller light quantity than the incident light LT1.

Further, because the lens substrate 200 has indentations on the incident face 200N, the difference in refractive index between air and the lens substrate 200 can be further reduced to continuously vary the refractive index. Thus, reflection of external light on the lens substrate 200 can be suppressed.

### 2-3. Operation and Effects

Configured as above, the lens processing apparatus 1 shines a light beam on the lens substrate 200 formed of an optical glass.

The lens substrate 200 irradiated with a light beam of a predetermined light quantity undergoes a thermochemical reaction as a result of a local temperature increase in the vicinity of the focal point, and a pit is formed. The lens processing apparatus 1 forms pits in such a manner that the pits gradually decrease in volume toward inside the lens substrate 200 away from the incident face 200N. The lens processing apparatus 1 also shines a light beam onto the incident face 200N of the lens substrate 200 to form indentations.

Thus, in the lens substrate 200, the volume percentage of pits with respect to the material gradually becomes smaller toward inside away from the incident face 200N.

Thus, the refractive index of the lens substrate 200 continuously varies toward inside the lens substrate 200 away from the air side, and does not vary abruptly. Reflection of externally incident light at the surface of the lens substrate 200 can thus be suppressed.

Further, because the lens processing apparatus 1 uses the integrated control unit 11 to control the light beam shone on the lens substrate 200, the volume of individual pits in the lens substrate 200 can be freely set.

The lens processing apparatus 1 is thus able to set the extent of refractive index change with great freedom over the range extending from the incident face 200N of the lens substrate 200 into the substrate.

The lens substrate 200 of Second Embodiment also has advantages substantially the same as those described in conjunction with the lens substrate 100 of First Embodiment.

According to the foregoing configuration, the lens processing apparatus 1 shines a light beam on the lens substrate 200 under the control of the integrated control unit 11, and forms pits in such a manner that the pits gradually decrease in volume toward inside the lens substrate 200 away from the substrate surface. Thus, the refractive index of the lens substrate 200 continuously varies toward inside the lens substrate 200 away from the air side. The lens processing apparatus 1 is therefore able to gradually vary the depth range refractive index of the lens substrate 200 from the refractive index of air to the refractive index of the material toward inside the substrate away from the incident face 200N, and set the extent of refractive index change with great freedom.

### 3. Third Embodiment

### 3-1. Configuration of Pit Forming Apparatus

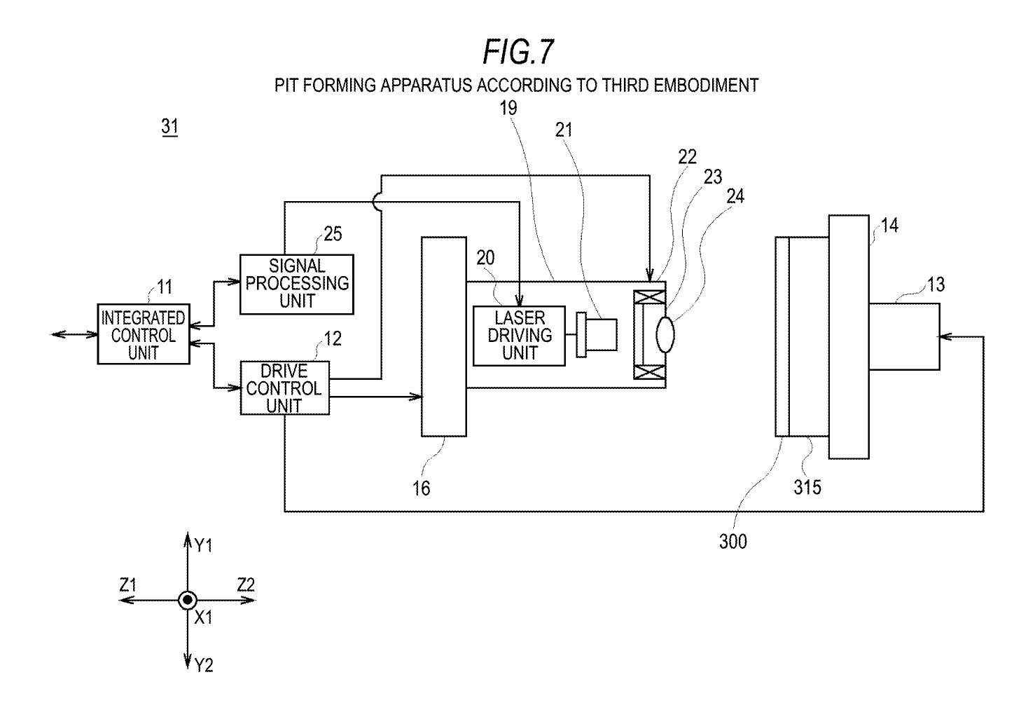

A pit forming apparatus 31 (FIG. 7) of Third Embodiment differs from the lens processing apparatus 1 of First Embodiment in that a light beam is shone on an anti-reflective sheet 300 to form pits.

Unlike the lens processing apparatus 1, the pit forming apparatus 31 does not include the tool anchoring unit 17 and the tool 18. The other configuration is the same except that a sheet anchoring unit 315 that anchors the anti-reflective sheet 300 is provided instead of the lens anchoring unit 15.

As with the lens substrate 100 of First Embodiment, the anti-reflective sheet 300 is made of a material that forms a pit as a result of a thermochemical reaction following a local temperature increase in the vicinity of the focal point of a light beam of a predetermined light quantity shone on the material.

The anti-reflective sheet 300 allows for passage of incident light from one surface to the other with high transmittance. The anti-reflective sheet 300 has a refractive index of about 1.5, as with the lens substrate 100 of First Embodiment.

Further, the anti-reflective sheet 300 is a flexible sheet thinner than the lens substrate 100 (along the Z direction). Thus, the anti-reflective sheet 300 can be attached to conform to the surface shape of various objects.

In the actual forming of the pits in the anti-reflective sheet 300, the drive control unit 12 rotates the spindle motor 13 under the control of the integrated control unit 11 to cause the rotation of the main shaft 14 and the anti-reflective sheet 300 anchored on the lens anchoring unit 15.

The drive control unit 12 then moves the support unit 16 to bring the optical unit 19 closer to the anti-reflective sheet 300.

The signal processing unit 25 then drives the laser diode 21 under the control of the integrated control unit 11, and causes the laser diode 21 to emit a light beam of a predetermined light intensity. The objective lens 24 at a controlled position focuses the light beam to a position distant apart from the surface of the anti-reflective sheet 300 by a desired distance (depth) along the Z direction.

In this manner, the pit forming apparatus 31 is adapted to form pits using a light beam that is shone upon moving the optical unit 19 over a wide range with the support unit 16, and moving the objective lens 24 toward and away from the anti-reflective sheet 300.

### 3-2. Formation of Pits

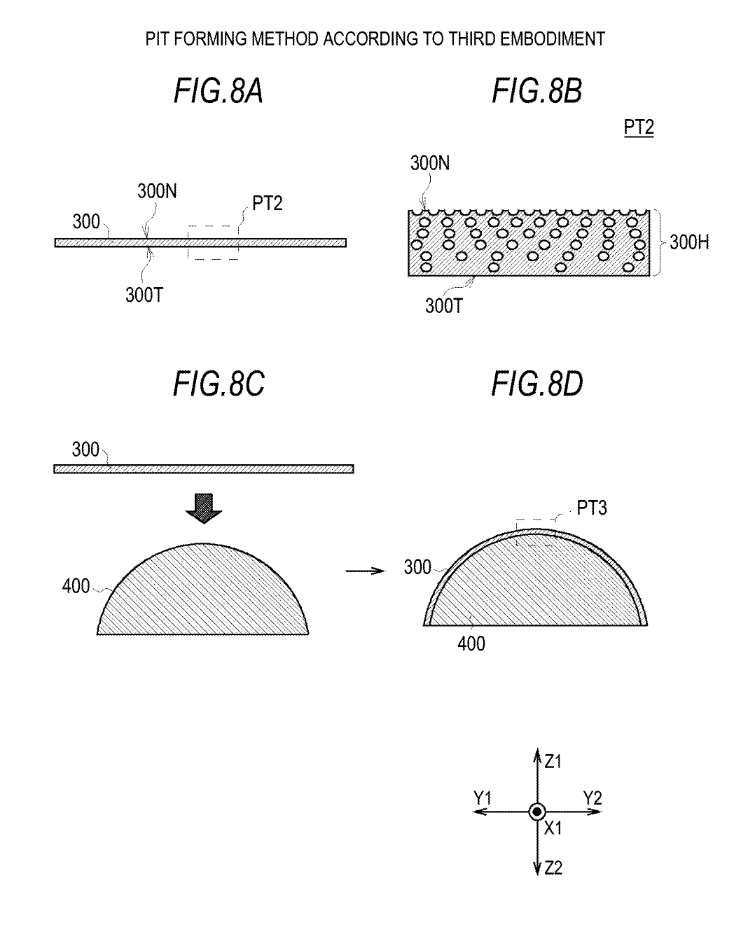

FIG. 8A illustrates the anti-reflective sheet 300 of the present embodiment. As in First Embodiment, the pit forming apparatus 31 controls the objective lens 24 with the drive control unit 12, and forms the pits by shining a light beam at a focal point position that is gradually moved toward the incident face 300N of the anti-reflective sheet 300 from a position farther away from the incident face 300N.

The pit forming apparatus 31 forms pits of substantially the same volume in gradually increasing densities under the control of the signal processing unit 25 as in First Embodiment, by moving the focal point position toward the incident face 300N of the anti-reflective sheet 300 from a position farther away from the incident face 300N.

FIG. 8B is a magnified cross sectional view of an anti-reflective sheet portion PT2 in part of the anti-reflective sheet 300 illustrated in FIG. 8A. As illustrated in FIG. 8B, pits are formed in the anti-reflective sheet 300 in three dimensions in the X, Y, and Z directions, and the pits in the Z direction form layers.

In the lens substrate 100 of First Embodiment, the pits are formed over a certain distance from the incident face 100N of the lens substrate 100 (specifically, over the range of the pit forming portion 100H). However, in the lens substrate 100, no pits are formed in the optically functional portion 100L farther down the lens substrate 100, and this portion of the lens substrate 100 is solely the material of the lens substrate 100. In other words, the pits are formed only in the vicinity of the surface of the lens substrate 100.

In contrast, the anti-reflective sheet 300, thinner than the lens substrate 100, includes pits over the whole distance from the incident face 300N (Z1 side) irradiated with a light beam to the transmission face 300T (Z2 side) in contact with a lens 400. In the following, the portion of the anti-reflective sheet 300 where the pits are formed is also referred to as a pit forming portion 300H. As in the pit forming portion 100H of the lens substrate 100 of First Embodiment, the pit forming portion 300H includes pits of substantially the same volume in gradually decreasing densities toward inside, away from the incident face 300N.

As illustrated in FIG. 8C, in the present embodiment, reflection of light is prevented with the anti-reflective sheet 300 having pits, by attaching it to the surface of the lens 400 where reflection needs to be prevented.

As illustrated in FIG. 8D, the anti-reflective sheet 300 having pits is attached to the lens 400 in such a manner that the transmission face 300T conforms to the curved surface of the lens 400. The lens 400 has a refractive index of about 1.5 throughout.

### 3-3. Varying Refractive Index

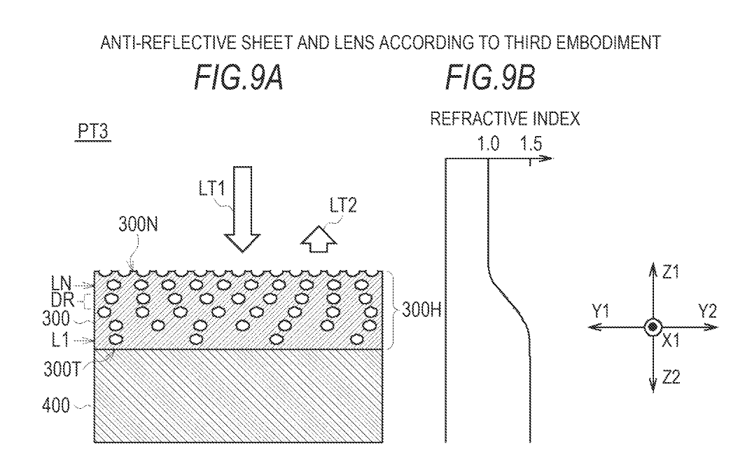

FIG. 9A is a magnified cross sectional view of an anti-reflective sheet portion PT3 in part of the anti-reflective sheet 300 and the lens 400 illustrated in FIG. 8D.

As illustrated in FIG. 9A, the anti-reflective sheet 300 includes pits of substantially the same volume in gradually decreasing densities away from the incident face 300N. FIG. 9A also shows incident light LT1 entering from the air side, i.e., outside the anti-reflective sheet 300, onto the lens 400 attached to the anti-reflective sheet 300.

Thus, in the anti-reflective sheet 300, the volume percentage of the pits with respect to the material of the anti-reflective sheet 300 in the depth range DR gradually decreases toward the transmission face 300T away from the incident face 300N.

The refractive index of the pits is about 1.0, substantially the same as the refractive index of air outside the anti-reflective sheet 300. The anti-reflective sheet 300 has a refractive index of about 1.5.

Thus, as represented in FIG. 9B, the depth range refractive index of the anti-reflective sheet 300 gradually increases from 1.0 to 1.5 as in First Embodiment toward the transmission face 300T away from the incident face 300N.

In the pit layer LN, the depth range refractive index is about 1.0, because of the high pit density attributed to the very large numbers of pits formed in the layer. Thus, there is only a small difference in refractive index at the interface between air and the anti-reflective sheet 300.

In contrast, the depth range refractive index is about 1.5 in the pit layer L1, because the number of pits formed in the layer is very small and thus the pit density is low. Accordingly, the depth range refractive index of the anti-reflective sheet 300 in the vicinity of the transmission face 300T becomes about 1.5, substantially the same as the refractive index of the lens 400. Accordingly, there is only a small difference in refractive index at the interface between the anti-reflective sheet 300 and the lens 400.

Thus, as illustrated in FIG. 9A, the reflected light LT2 that occurs as the incident light LT1 is reflected at the anti-reflective sheet 300 has a much smaller light quantity than the incident light LT1.

Further, the anti-reflective sheet 300 has indentations on the incident face 300N. Thus, the difference in refractive index between air and the anti-reflective sheet 300 can be further reduced to continuously vary the refractive index. Reflection of external light on the anti-reflective sheet 300 can be suppressed this way.

### 3-4. Operation and Effects

Configured as above, the pit forming apparatus 31 shines a light beam on the anti-reflective sheet 300 of a material that forms a pit by a thermochemical reaction that occurs as a result of a local temperature increase in the vicinity of the focal point of an irradiated light beam of a predetermined light quantity.

The pit forming apparatus 31 forms pits of substantially the same volume in the flexible and thin, anti-reflective sheet 300 in such a manner that the pit density gradually decreases toward the transmission face 300T away from the incident face 300N.

Thus, the volume percentage of the pits with respect to the material of the anti-reflective sheet 300 gradually becomes smaller in the anti-reflective sheet 300 toward the transmission face 300T away from the incident face 300N.

The anti-reflective sheet 300 having pits is attached to the lens 400 in such a manner that the transmission face 300T opposite the incident face 300N is in contact with the lens 400.

The anti-reflective sheet 300 is therefore able to continuously vary the refractive index over the range from the air side to the lens 400, and thus there is no abrupt change in refractive index. Reflection of externally incident light on the anti-reflective sheet 300 can thus be suppressed.

Further, the anti-reflective sheet 300 has substantially the same refractive index as the lens 400. This enables the anti-reflective sheet 300 to relieve the reflection of light that occurs because of the difference in refractive index between the anti-reflective sheet 300 and the lens 400 upon the incidence of external light on the lens 400 through the anti-reflective sheet 300.

Further, because the anti-reflective sheet 300 of the present embodiment has a form of a sheet, the anti-reflective sheet 300 can be used to suppress reflection of external light by being attached to, for example, a lens of a material that does not allow for formation of the pits by irradiation of a light beam.

The anti-reflective sheet 300 also can be attached to suppress reflection of external light even when the lens 400 has a complex surface shape that makes the accurate focusing of a light beam difficult for the pit formation.

Further, because the pit forming apparatus 31 uses the integrated control unit 11 to control the light beam shone on the anti-reflective sheet 300, the distribution density of the pits in the anti-reflective sheet 300 can be freely set.

The pit forming apparatus 31 is therefore able to set the extent of refractive index change with great freedom over the range from the surface of the anti-reflective sheet 300 to the lens 400 attached to the anti-reflective sheet 300.

The anti-reflective sheet 300 of Third Embodiment also has advantages substantially the same as those described in conjunction with the lens substrate 100 of First Embodiment.

According to the foregoing configuration, the pit forming apparatus 31 forms pits of substantially the same volume in the anti-reflective sheet 300 under the control of the integrated control unit 11 in such a manner that the pit density gradually decreases toward the transmission face 300T away from the incident face 300N. The anti-reflective sheet 300 having the pits is attached to the lens 400 with the transmission face 300T in contact with the lens 400. In this way, the pit forming apparatus 31 can gradually vary the depth range refractive index of the anti-reflective sheet 300 from the refractive index of air to the refractive index of the material in a direction from the incident face 300N to the transmission face 300T, and can set the extent of refractive index change with great freedom.

### 4. Other Embodiments

The foregoing First Embodiment described varying the distribution density of the pits in the lens substrate 100 according to the distance from the incident face 100N. In Second Embodiment, the volume of individual pits was varied according to the distance from the incident face 200N.

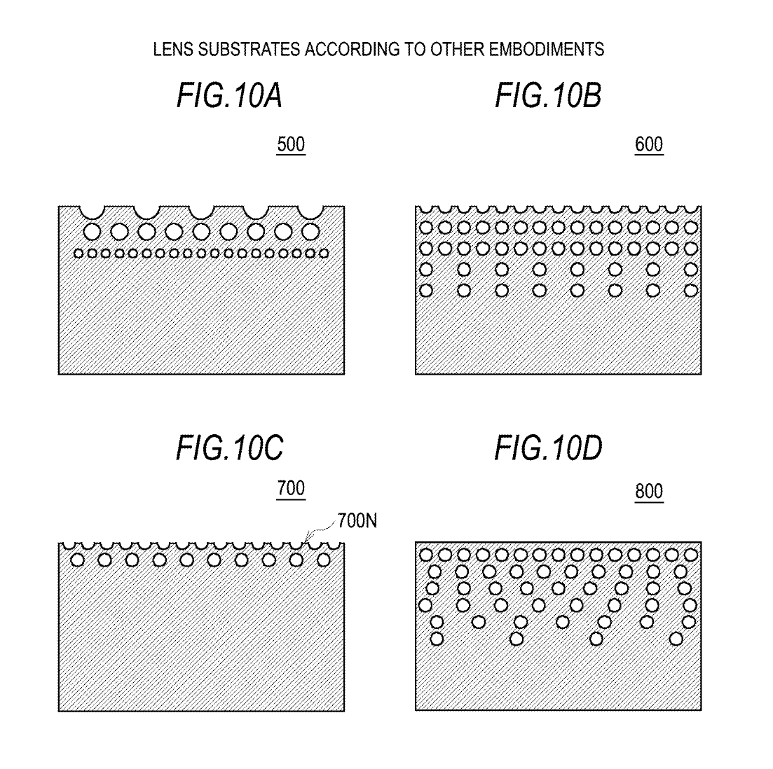

However, the present invention is not limited to these, and the distribution density of pits and the volume of individual pits may be varied in combination as in, for example, a lens substrate 500 illustrated in FIG. 10A, in which the distribution density of pits and the volume of individual pits vary layer to layer in the lens substrate 500.

The foregoing First Embodiment described forming pits in such a manner that the pits gradually decrease in density across the layers toward inside the lens substrate 100 away from the incident face 100N.

However, the present invention is not limited to this, and more than one layer with the same pit density may be formed as in, for example, a lens substrate 600 illustrated in FIG. 10B. Likewise, more than one layer with the same pit volume may be formed in the configuration of Second Embodiment, though not illustrated. Furthermore, only a single pit layer may be formed in the vicinity of an incident face 700N as in a lens substrate 700 illustrated in FIG. 10C. This configuration is also possible in Second and Third Embodiments.

In short, the pits may be formed in any ways as long as the depth range refractive index of the lens substrate 100 gradually varies from a refractive index substantially the same as that of air, to a refractive index substantially the same as that of the material of the lens substrate 100, in a direction from outside to inside the lens substrate 100.

The foregoing First Embodiment described shining a light beam on the incident face 100N of the lens substrate 100 to form indentations on the incident face 100N of the lens substrate 100.

However, the present invention is not limited to this, and the indentations may not be formed on the lens substrate surface, as in, for example, a lens substrate 800 illustrated in FIG. 10D. In this way, the lens substrate 800 can suppress reflection of light under no influence of damages caused by external contact, or adhesion of liquid. This configuration is also possible in Second and Third Embodiments.

The foregoing Second Embodiment described adjusting the pit volume by varying the irradiation time of a light beam on the lens substrate 200.

However, the present invention is not limited to this, and the pit volume may be adjusted by varying the intensity of the light beam shone on the lens substrate 200, or by varying the irradiation time and the intensity of the light beam in combination.

The foregoing First Embodiment described the lens substrate 100 formed of an optical glass in which pits are formed as a result of a thermochemical reaction following a local temperature increase in the vicinity of the focal point of a light beam of a predetermined light quantity shone on the substrate.

However, the present invention is not limited to this, and the lens substrate 100 may be formed of an optical glass in which pits are formed as a result of photo irradiation of a light beam, in addition to a temperature increase in the vicinity of the focal point.

Instead of optical glass, optical crystal such as fluorite, quartz, silicon, and germanium, or plastic such as a polycarbonate resin may be used.

The pits are not necessarily required. For example, a photopolymerizable photopolymer may be used, and the refractive index in the vicinity of a focal point may be varied by causing a photopolymerization reaction and/or a photocrosslinking reaction in the vicinity of the focal point of a light beam.

In short, any material can be used as long as the material can vary its refractive index by undergoing state changes as a result of various types of reaction in the vicinity of a focal point upon irradiation of a light beam. This is also the case for Second and Third Embodiments.

The target of anti-reflection process is not necessarily limited to the lens, and may be, for example, a solar panel or a protection panel for displays. In short, the anti-reflection process can be applied to any object for which the surface reflection of light needs to be prevented while allowing for passage of incident light.

The foregoing First Embodiment described forming pits of substantially the same volume within a predetermined layer inside the lens substrate 100.

However, the present invention is not limited to this, and the pits within the same layer may have different volumes to certain extent. However, the anti-reflection effect can be more uniformly obtained over a wide range on the XY plane when pits of the same volume are spread over the XY plane in the same layer (FIGS. 3A to 3E).

Further, in the foregoing First Embodiment, the depth range DR was described as being a range that includes a single pit layer distant apart from the incident face 100N by a predetermined distance.

However, the present invention is not limited to this, and the depth range DR may be a range that includes a plurality of pits in a direction normal to the incident face 100N. This configuration is also possible in Second and Third Embodiments.

Further, in the foregoing First Embodiment, the optically functional portion 100L of the lens substrate 100 was described as being optically functional to transmit and condense incident parallel rays.

However, the present invention is not limited to this, and the optically functional portion 100L may have various optical functions, for example, including transmitting and diverging incident parallel rays. Further, for example, the optical function may be simply the function to transmit incident light. This is also the case for Second Embodiment.

The foregoing embodiments described moving the focal point position of a light beam by lightly moving the objective lens 24.

However, the present invention is not limited to this. For example, the light beam emitted by the laser diode 21 may be condensed by the objective lens 24 through an expander lens movable along the direction of the light path of the light beam, and the focal point position may be moved by varying the divergence angle of the incident light beam on the objective lens 24 by moving the expander lens.

In the foregoing Third Embodiment, the anti-reflective sheet 300 and the lens 400 were described as having substantially the same refractive index.

However, the present invention is not limited to this, and the anti-reflective sheet 300 and the lens 400 may have different refractive indices to certain extent. However, the amount of reflected light at the interface between the anti-reflective sheet 300 and the lens 400 becomes smaller as the difference in refractive index between the anti-reflective sheet 300 and the lens 400 becomes smaller.

The foregoing First Embodiment described controlling the objective lens 24 using the drive control unit 12, and sequentially forming pits by moving the focal point position of a light beam in a direction normal to the incident face 100N.

However, the present invention is not limited to this, and the objective lens 24 and the support unit 16 may be controlled together using the drive control unit 12 to move the focal point position of a light beam in a direction normal to the incident face 100N. This configuration is also possible in Second Embodiment.

Further, the foregoing embodiments described the lens substrates 100 and 200, and the anti-reflective sheet 300 provided as optical elements that include the pit forming portions 100H, 200H, and 300H, respectively.

However, the present invention is not limited to this, and the optical element may be configured to include various forms of other pit forming portions.

The foregoing embodiments described the lens processing apparatus 1 and the pit forming apparatus 31 configured as processing apparatuses for reducing reflection that include the laser diode 21 (light source), the objective lens 24 (objective lens), the drive control unit 12 (moving unit), the integrated control unit 11 (control unit), and the signal processing unit 25 (control unit).

However, the present invention is not limited to this, and the lens processing apparatus 1 and the pit forming apparatus 31 may be configured as processing apparatuses for reducing reflection that include a light source, an objective lens, a moving unit, and a control unit of various other circuit configurations.

The present invention is usable for optical elements for which surface reflection of light needs to be prevented.

The present application contains subject matter related to that disclosed in Japanese Priority Patent Application JP 2009-195688 filed in the Japan Patent Office on Aug. 26, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An optical element comprising:
a pit forming portion of a material that forms a pit in the vicinity of each focal point of a predetermined light beam upon condensation, wherein the pits are formed in such a manner that the volume percentage of the pits with respect to the material at distances from a light incident face becomes smaller away from the incident face.

2. The optical element according to claim 1, wherein the pit forming portion includes the pits at least at different distances from the incident face.

3. The optical element according to claim 2, wherein the pit forming portion forms the pits in substantially the same volume and in decreasing densities away from the incident face over a range of substantially a constant distance from the incident face.

4. The optical element according to claim 2, wherein the pit forming portion includes the pits in decreasing volumes away from the incident face.

5. The optical element according to claim 1, further comprising an optically functional portion of the same material as that of the pit forming portion and integral therewith on the opposite side from the incident face of the pit forming portion, and that has a predetermined optical function for the light incident through the pit forming portion.

6. The optical element according to claim 1, wherein the incident face has indentations.

7. The optical element according to claim 1, wherein the material has substantially the same refractive index as a material of another optical element in contact with a surface opposite from the incident face of the pit forming portion.

8. A processing apparatus for reducing reflection comprising:
a light source that emits a light beam;
an objective lens that condenses the light beam to form pits inside an optical element of a predetermined material;
a moving unit that moves a focal point position of the light beam; and
a control unit that controls the light source and the moving unit to form the pits inside the optical element in such a manner that the volume percentage of the pits with respect to the material at distances from a light incident face of the optical element becomes smaller away from the incident face.

9. The processing apparatus according to claim 8, wherein the control unit controls the light source and the moving unit in such a manner that the pits are sequentially formed toward the incident face from a position farther away from the incident face.

10. A processing method for reducing reflection,
the method comprising the steps of:
moving a focal point position of a light beam with respect to an optical element of a material that forms a pit in the vicinity of each focal point of a predetermined light beam upon condensation; and
shining the light beam to form the pits inside the optical element in such a manner that the volume percentage of the pits with respect to the material at distances from a light incident face of the optical element becomes smaller away from the incident face.
